(19) United States
(12) Patent Application Publication
(10) Pub. No.: US 2013/0090060 A1
(43) Pub. Date: Apr. 11, 2013

(54) WIRELESS MODEM

(71) Applicant: Ok Chae Kim, San Diego, CA (US)

(72) Inventor: Ok Chae Kim, San Diego, CA (US)

(73) Assignee: Franklin Wireless Corporation, San Diego, CA (US)

(21) Appl. No.: 13/253,459

(22) Filed: Oct. 5, 2011

(51) Int. Cl. H04W 84/02; H04W 4/00; G06F 13/38

(52) U.S. Cl. 455/41.2

(57) ABSTRACT

A wireless modem is disclosed. In one embodiment, the wireless modem includes a first transceiver configured to wirelessly transmit and receive first data according to a long-range communication standard and a second transceiver configured to wirelessly transmit and receive second data according to a short-range communication standard. The modem may further include a wireless interface configured to wirelessly communicate the second data with a first computing device according to the short-range communication standard and a controller configured to perform a signal conversion between the first data and second data.

### BACKGROUND

1. Field

The described technology generally relates to a wireless modem, for example a universal serial bus (USB) modem, for communicating data. The data may be transmitted between one or more client devices and/or one or more cellular cell sites.

2. Description of the Related Technology

With the proliferation of high speed mobile internet services, an increasing number of wireless modems utilize high bandwidth wireless technologies. Examples of such modems include a USB dongle type modem. A USB dongle type modem can be connected to a USB port of a computing device to provide broadband internet access within 3G or WiMax networks, and a portable wireless local area network (WLAN) hot-spot modem.

High bandwidth wireless technologies include code division multiple access (CDMA), global system for mobile (GSM), evolution data only (EVDO), high speed packet access (HSPA), long term evolution (LTE), and WiMax technologies, etc., offered by commercial cellular service providers. Those high bandwidth wireless networks are hereinafter referred to as wireless wide area network (WWAN), to be distinguished from short-range wireless networks such as WLAN (or Wi-Fi according to IEEE 802.11b/g/n), Blue Tooth and Zigbee which cover a limited area, for example, inside a commercial building or residence.

### SUMMARY

The devices, systems, and methods of the present disclosure have several features, no single one of which is solely responsibly for its desirable attributes. Without limiting the scope of this invention as expressed by the claims which follow, its more prominent features will now be discussed briefly. After considering this discussion, and particularly after reading the section entitled “Detailed Description,” one will understand how the features of this disclosure provide several advantages over other wireless modems.

One inventive aspect is a wireless USB modem which is attached to a client device so as to communicate data with the client device and wirelessly communicate data with at last one client device which is located remotely from the USB modem.

Another aspect is a wireless USB modem which can wirelessly communicate data with a client device without the need for a USB driver or CM program being in the client device.

Another aspect is a wireless USB modem (standalone or hostless modem) which can be plugged into an external power source and wirelessly communicate data with at least one client device which is located within WLAN (Wi-Fi) coverage (or other short distance wireless network that can be used in a building or home), even if the USB modem is not physically connected to the client device.

Another aspect is a wireless USB modem which provides a WLAN interface to a client device located within WLAN coverage regardless of the type of operating system on the client device.

Another aspect is a wireless USB modem which can selectively provide a physical USB interface or a WLAN interface to a client device that is connected to the USB modem.

Another aspect is a wireless USB modem which can be physically connected to a client's device without the client having to select specific USB driver software for a specific operation systems (OS) and installing the USB driver software and CM application program on their device.

Another aspect is a wireless USB modem which allows for a client device to control and monitor data connection and WWAN connections using a commercially available web user interface (web UI) without having to install CM application software.

Another aspect is a wireless universal serial bus (USB) modem comprising: a wireless wide area network (WWAN) transceiver configured to transmit and receive WWAN data via a public wireless network; a physical USB interface configured to communicate USB data with and/or receive power from a first computing device; a WWAN interface configured to interface between the USB data and the WWAN data; a wireless local area network (WLAN) transceiver configured to transmit and receive WLAN data via a WLAN; a WLAN interface configured to communicate data, via the WLAN, with the first computing device and/or at least one second computing device which is not physically connected to the modem; a memory configured to store a USB driver program and a connection manager program, and a web user interface program; and a controller being in data communication with the memory and configured to selectively activate the physical USB interface or the WLAN interface.

Another aspect is a wireless modem comprising: a first transceiver configured to wirelessly transmit and receive first data according to a wireless long-range communication standard; a second transceiver configured to wirelessly transmit and receive second data according to a wireless short-range communication standard; a wireless interface configured to wirelessly communicate the second data with a first computing device according to the short-range communication standard; and a controller configured to perform a signal conversion between the first data and second data.

Another aspect is a method of operating a wireless universal serial bus (USB) modem comprising: wirelessly transmitting and receiving first data according to a long-range communication standard; wirelessly transmitting and receiving second data according to a short-range communication standard; wirelessly communicating the second data with a first computing device according to the short-range communication standard; and performing, at a wireless USB modem, a signal conversion between the first data and the second data.

Another aspect is a wireless universal serial bus (USB) modem, comprising: means for wirelessly transmitting and receiving first data according to a long-range communication standard; means for wirelessly transmitting and receiving second data according to a short-range communication standard; means for wirelessly communicating the second data with a first computing device according to the short-range communication standard; and means for performing, at a wireless USB modem, a signal conversion between the first data and the second data.

### BRIEF DESCRIPTION OF THE DRAWINGS

The above mentioned and other features of this disclosure will now be described with reference to the drawings of several embodiments of the present wireless modem, systems, and methods of use. The illustrated embodiments of the modem, systems, and methods are intended to illustrate, but not to limit the disclosure. The drawings contain the following figures:

FIG. 1 is a wireless data communication network including a comparative wireless USB modem configured to provide wireless data communication between a client device and a wireless cell site.

FIG. 2 illustrates an example data layer structure for use with the wireless data communication network shown in FIG. 1.

FIG. 3 is a wireless data communication network including a wireless USB modem according to one embodiment.

FIG. 4 illustrates an example data layer structure for use with the wireless data communication network shown in FIG. 3.

FIG. 5 illustrates a functional block diagram of one embodiment of the wireless USB modem from FIG. 3.

FIG. 6 is a flowchart showing one exemplary use and operation of the wireless USB modem from FIG. 3.

FIG. 7 illustrates two exemplary screenshots of a web UI that is displayed on a screen of a client device by the wireless USB modem from FIG. 3.

### DETAILED DESCRIPTION

Embodiments will be described with respect to the accompanying drawings. Like reference numerals refer to like elements throughout the detailed description.

Wireless modems attached to client devices allow wireless data transfer between client devices and cellular cell sites, enable clients to browse internet, and to send or receive emails from their fixed or portable computing devices. An exemplary communication standard is the universal serial bus (USB) protocol. USB (Universal Serial Bus) is an industry standard that defines the cables, connectors and protocols used for connection, communication and power supply between computers and electronic devices. Of course the wireless modem is not limited to use with any specific standard.

In order to have the USB modem physically connected to client devices, users of the client devices are generally required to install software in their devices. The software can include, for example, a USB driver and connection manager (CM) software. While USB modem manufacturers offer many USB drivers and CM programs, consumers still need to select the appropriate driver and program that is compatible with the operation system (OS) of their device.

Wireless USB modems generally have a baseband processor and a radio frequency (RF) unit to process a WWAN signal received from cellular cell sites. A typical wireless USB modem includes a modulator and a demodulator which perform a signal conversion between a USB data signal and a WWAN radio frequency (RF) signal. The wireless USB modem also includes a USB physical connector (e.g., USB port) which allows the modem to communicate data with a client device connected thereto. The USB physical connector also allows the USB modem to receive power from the connected client device.

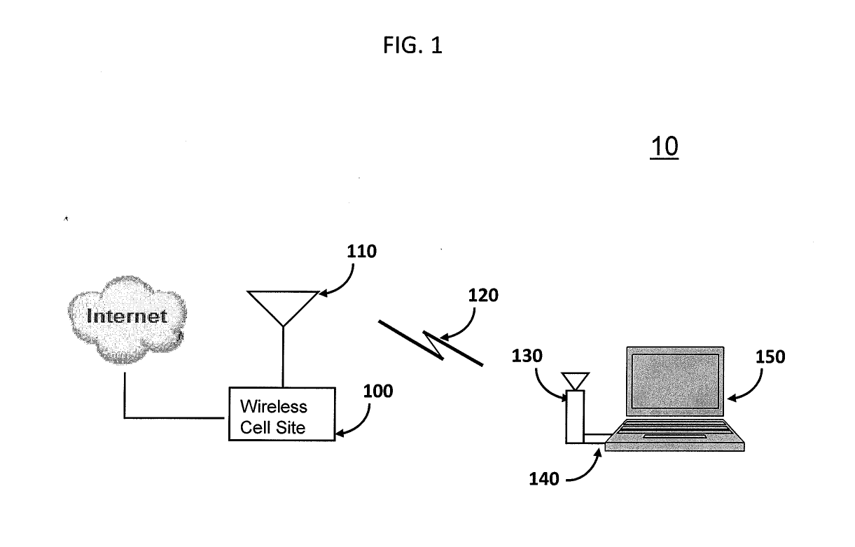

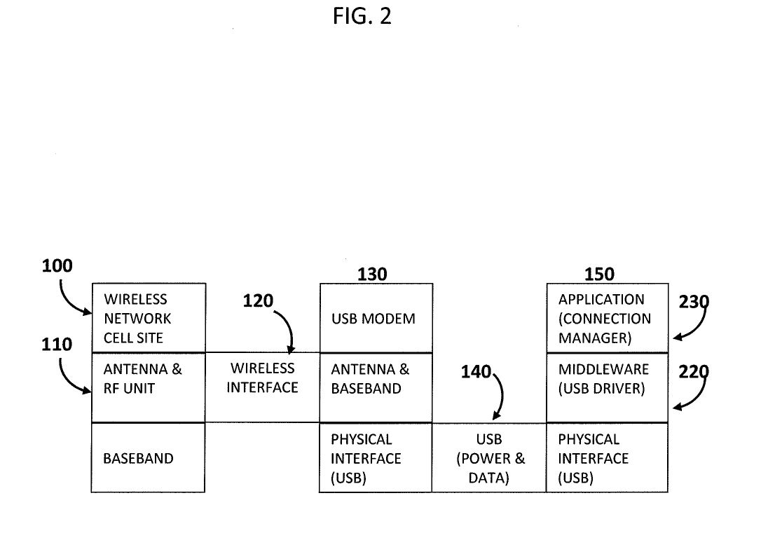

FIG. 1 is a wireless data communication network 10 including a comparative wireless USB modem 130. FIG. 2 illustrates an example data layer structure of the wireless data communication network 10 shown in FIG. 1. The wireless data communication network 10 includes a client device 150 and a wireless network cell site 100. The client device 150 and the wireless network cell site 100 wirelessly communicate RF data with each other via a public wireless network 120 provided by, for example, commercial cellular service providers.

The wireless network cell site 100 can be a base station or any other device or system connected to the Internet. An antenna and RF unit 110 is connected to the wireless network cell site 100. A wireless USB modem 130 and the client device 150 establish a USB connection 140 via respective physical USB interfaces (e.g., USB ports). The USB modem 130 receives power from and communicates data with the client device 150 via the established USB interface 140. The wireless USB modem 130 and the antenna and RF unit 110 allow the client device 150 and the wireless network cell site 100 to wirelessly communicate RF data with each other via the public wireless network 120.

The USB modem 130 may include additional elements (software or hardware) such as an encoder, a decoder and a processor (not shown) so as to convert RF data, received from the cell site 100, to USB data, and transmit the converted data to the client device 150, and to convert USB data, received from the client device 150, to RF data, and transmit the converted data to the cell site 100.

In order to connect the USB modem 130 to the client device 150, a user is required to install a USB driver 220 (see FIG. 2). The user is also prompted to install a connection manager (CM) program 230 which runs on the operating system of the client device 150 and allows the user to control and monitor wireless data transmission status in the cellular network subscribed to by the user. The USB driver 220 and CM programs 230 are typically stored in a USB modem memory or provided in a separate optical storage medium such as a compact disk (CD) or a digital video disk (DVD).

The USB modem 130 provides only the physical USB interface 140 for physically connecting with the single client device 150, which limits its connectivity. For example, when the user plugs the USB modem 130 into another client device, the user must install the appropriate USB driver and CM software into the other client device. Furthermore, the USB modem 130 can not operate as a standalone device even if the modem 130 receives power from an external power source because the modem 130 cannot wirelessly communicate data with a client device. Moreover, USB Modem manufacturers have to provide different USB deriver and CM programs which are compatible with various operation systems of different client devices such as Windows, Macintosh, Linux, Android and iOS.

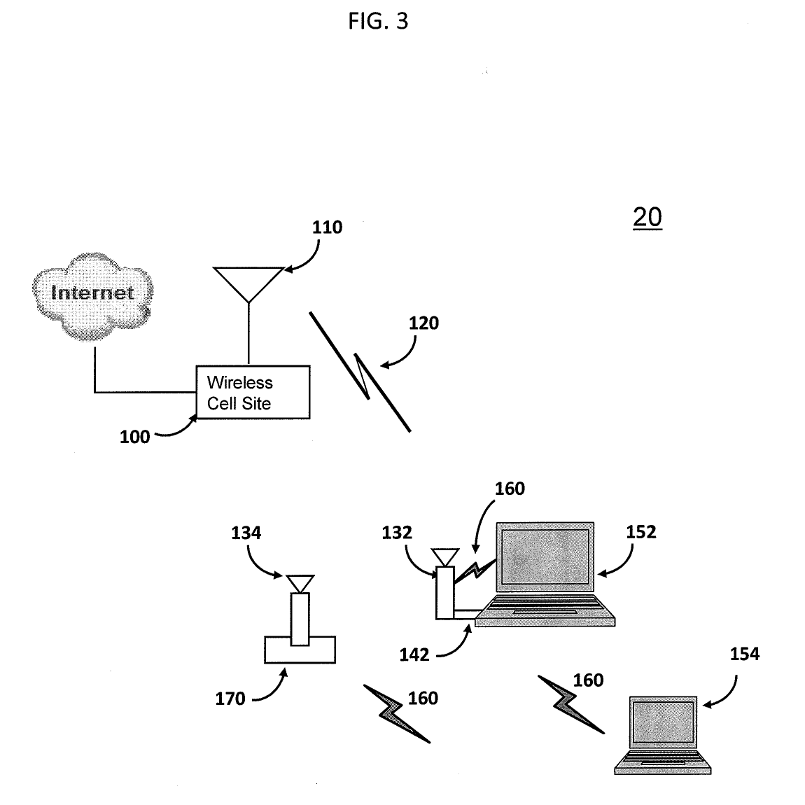

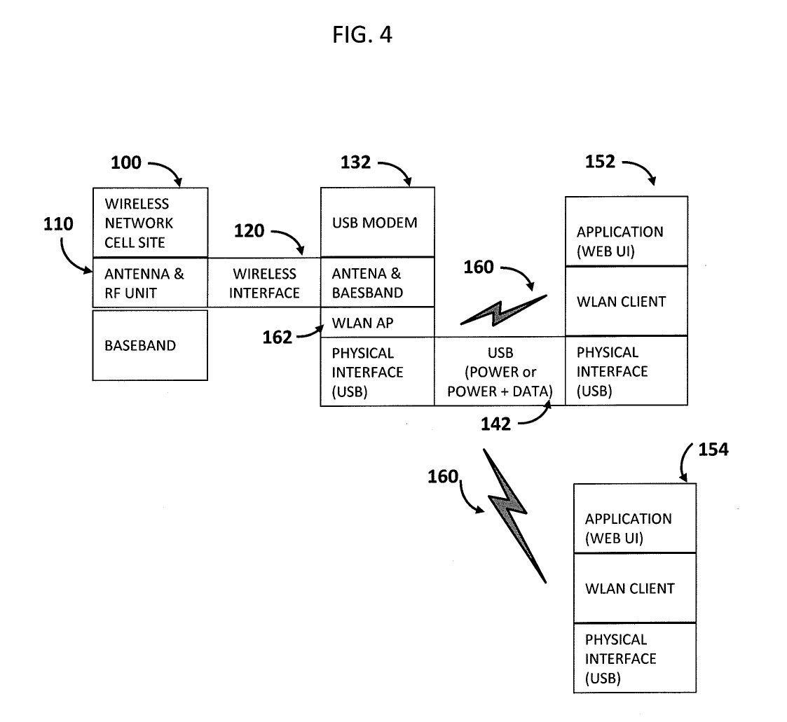

FIG. 3 is an embodiment of a wireless data communication network 20 that includes a wireless USB modem 132 according to one embodiment. FIG. 4 illustrates an example data layer structure of the wireless data communication network 20 shown in FIG. 3.

The wireless data communication network 20 includes a client device 152 and a wireless network cell site 100 which wirelessly communicate data with each other via a public wireless network 120. The client device 152 can be any computing device, including but not limited to, a desktop computer, a laptop computer, a tablet computer, a smart phone, a personal digital assistant or any other computing device that can communicate data with the USB modem 132.

In one embodiment, the USB modem 132 includes a physical USB interface 142 and a wireless interface 160. The physical USB interface 142 establishes a physical connection between the modem 132 and the client device 152. The wireless interface 160 establishes a wireless link between the modem 132 and the client device 152 and/or at least one detached client device 154. In the illustrated embodiment, a user may select one or both of the two interfaces 142 and 160 for the USB modem 132 to communicate data with the client device.

For example, if the USB modem 132 is physically connected to the client device 152 and the user selects the physical interface 142, the USB modem 132 performs data communication based on the selected physical interface. In one embodiment, upon the user's selection, the USB modem 132 receives power from the attached client device 152, and communicates data with the client device 152 via the physical USB interface 142 (“power+data communication” mode). In this embodiment, the user is prompted to install USB driver and CM programs, unless they are already installed in the client device 152.

In another embodiment, the USB modem 132 is physically connected to the client device 152 only for the purpose of power supply. In this embodiment, no wired data communication between the USB modem 132 and the client device 152 is required via the physical interface 142. Instead, a WLAN access point (AP) unit 162 allows the USB modem 132 to wirelessly communicate data with the client device 152 via the wireless interface 160 while receiving power from the client device 152 (“power supply” mode). The advantage of this power supply mode is that there is no need to install USB driver and CM programs in the client device 152. Furthermore, the USB modem 132 can provide the wireless interface 160 to at least one detached client device 154.

The modem 132 can also provide the wireless interface 160 to at least one detached client device 154. In this mode, the wireless modem 132 does not need to be plugged into the client device 154 via the USB port, since the USB modem 132 allows the client device 154 to wirelessly communicate data with the wireless cell site 100 via the wireless interface 160 and the public wireless network 120. Although FIG. 3 shows only one additional client device 154, two or more additional client devices can also access and share the wireless interface 160.

In this power supply mode, the USB modem 132 wirelessly communicates data with the attached client device 152 and/or at least one detached client device 154 via the wireless interface 160, while receiving power from the client device 152. That is, even if the USB modem 132 is physically connected to the client device 152, the modem 132 can wirelessly communicate data with wireless units of the client devices 152 and 154, without having to install a USB driver and CM program in the client devices 152 and 154. The wireless interface 160 may be a short-range wireless interface such as WLAN (or Wi-Fi according to IEEE 802.11b/g/n), Blue Tooth, Zigbee or any other short-range wireless interfaces which cover a limited area, for example, inside a commercial building or residence.

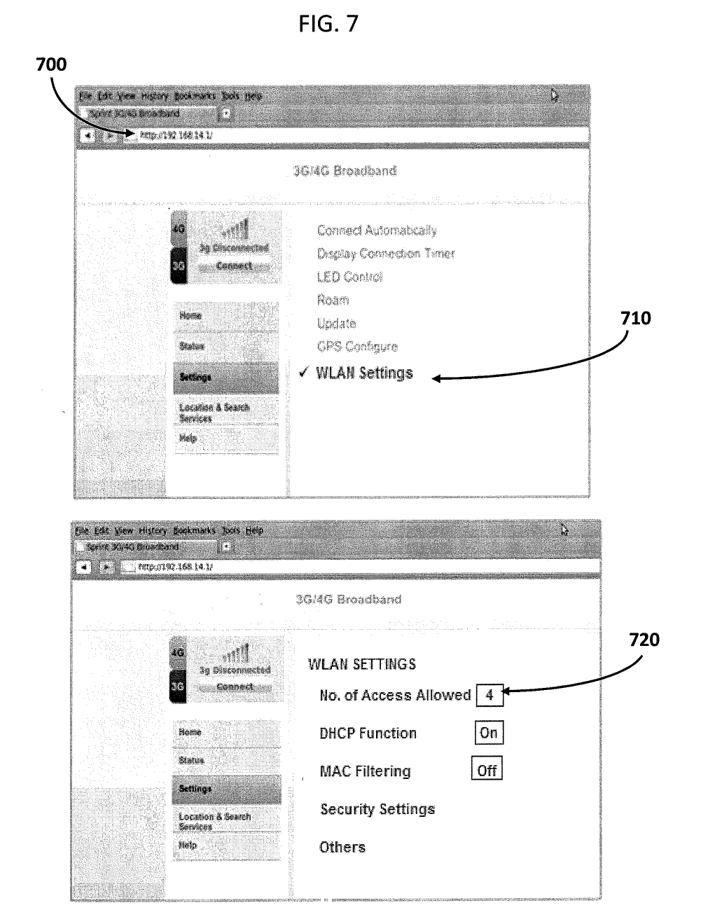

In one embodiment, the owner of the USB modem 132 uses a web user interface (UI) to limit the number of client devices accessing the USB modem 132 as shown in FIG. 7 (see the second screenshot of FIG. 7). The modem manufacturer may provide the web UI which can be displayed on a commercial internet browser. In order to use the web UI, a user may type in a dedicated Internet protocol (IP) address (for example, http://192.168.14.1) or a dedicated domain name in the address window of an Internet browser such as Microsoft Internet Explorer or Google Chrome Browser, etc., to access a modem configuration screen on the client device 152.

The web UI screen of FIG. 7 allows a user to control and monitor menus for the modem operation status and wireless data communication status between the wireless cell site 100 and the client device 152. In one embodiment, as shown in FIG. 7, a user clicks the “WLAN settings” menu on the web UI (710), which will lead to the WLAN settings sub menu. The user can type in the number of access allowance in the field named “No. of Access Allowed” (720). In FIG. 7, reference numeral 720 shows that a user has set the number of accessible client devices to four. The user can set different numbers. The USB modem 132 may also set up, using the web UI program, security to require a user of a client device to enter a password to access the WLAN USB interface 160 provided by the modem 132.

In another embodiment, a wireless USB modem 134 is physically connected to an external power source 170 (see FIG. 3). In this embodiment, the modem 134 can operate as a standalone device (e.g., as a portable WLAN Wi-Fi router) and does not need a physical connection with the client device 152. In one embodiment, the standalone modem 134 has the same configuration as the USB modem 132 so that the standalone modem 134 provides both the physical interface 142 and the wireless interface 160 when it is attached to a client device 152. In another embodiment, the USB modem 134 includes elements required only for the wireless interface function. In this embodiment, the USB modem 134 does not need to store USB driver and CM programs, and uses the physical USB interface 142 only for receiving power from the external power source 170 or the client device 152 connected thereto.

In one embodiment, the external power source 170 is a battery pack which has a USB female connector that can accept the counterpart of the USB modem 134. The battery pack can be charged with the use of a charging circuit or an electric power outlet. In another embodiment, the external power source 170 includes any device or machine that can be electrically wired or wirelessly connected to the USB modem for power supply via, for example, a regular size (type A) USB port provided in the modem 134. The USB modem 134 may additionally, or instead of the type A USB port, include a smaller USB port such as a mini B-type USB port or a micro B-type USB port. In this situation, the external power source 170 may include a smaller USB port corresponding to the smaller port of the USB modem 132.

Plugged into the external power source 170, the wireless USB modem 134 can establish a standalone hotspot modem without a physical connection with a client device. Again, multiple users can wirelessly connect their client devices 152 to the standalone USB modem 134 and can wirelessly communicate data with the wireless cell site 100 via the modem 134 and the public wireless network 120.

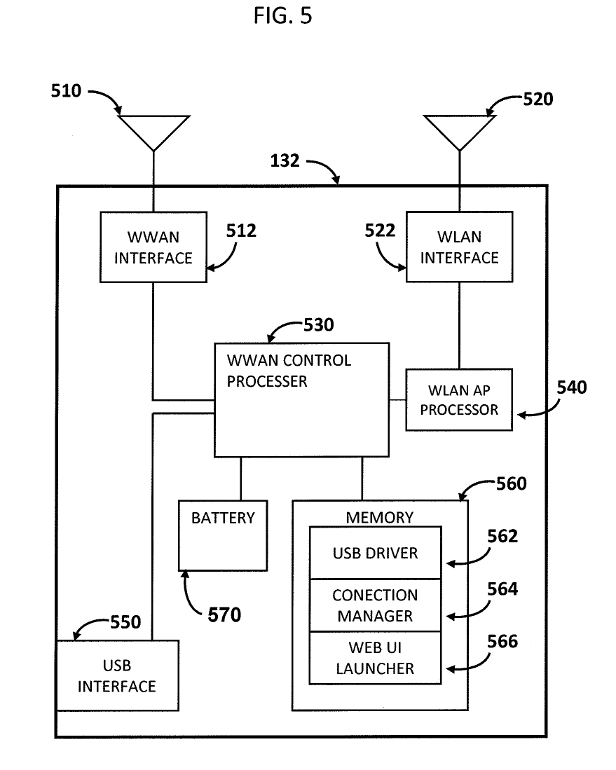

FIG. 5 illustrates a functional block diagram of the USB modem 132 according to one embodiment. The USB modem 132 includes a WWAN transmitter/receiver (or transceiver) 510, a WLAN transmitter/receiver (or transceiver) 520, a WWAN interface 512, a WLAN interface 522, a WWAN control processor 530, a WLAN AP processor 540, a USB interface 550, and a memory 560. Depending on the embodiment, additional elements may be added to and/or others removed from the modem 132 shown in FIG. 5. The WWAN interface 512 allows the USB modem 132 to wirelessly communicate data with the wireless cell site 100 via the WWAN transceiver 510 once a WWAN data connection is established therebetween. WWAN includes all cellular communication networks, including but not limited to, GSM, CDMA, EVDO, HSPA, LTE and WiMax. Although FIG. 5 shows WLAN elements, other short-range wireless interfaces (e.g., Blue Tooth or Zigbee) can also be used. However, exemplary WLAN elements are used for the purpose of description. Furthermore, the standalone modem 134 may have the same configuration as the modem 132. For the purpose of convenience, the operation and configuration of the modem 132 will be described.

The WWAN control processor 530 may supervise the overall operation of the modem 132. For example, the WWAN control processor 530 may perform a signal conversion between WWAN data received from the cell site 100 and USB data received from the client device 152. The WWAN control processor 530 may also forward WWAN data received from the WLAN AP processor 540 to the WWAN interface 512 to be transmitted to the cell site 100 via the public wireless network 120.

The WLAN interface 522 allows the USB modem 132 to wirelessly communicate data with a WLAN unit of the client device 152 or 154 via the WLAN transceiver 520 once the wireless interface 160 (e.g., WLAN) is established between the modem 132 and the client device 152 or 154. The WLAN AP processor 540 may control the WLAN operation of the modem 132. For example, the WLAN AP processor 540 may perform a signal conversion between WLAN data received from the client devices 152 and 154, and WWAN data received from the WWAN control processor 530.

In one embodiment the WLAN control processor 530 is a master and the WLAN AP processor 540 is a slave. In another embodiment the WLAN AP processor 540 is the master and the WLAN control processor 530 is the slave. The WLAN control processor 530 and WLAN AP processor 540 may be incorporated into a single processor or more than two processors. The single processor may also include the memory 560.

In one embodiment, the memory 560 stores a USB driver program 562, a connection manager program 564 and a web UI launcher 566. In another embodiment, the memory 560 does not store the USB driver program 562 and the connection manager program 564. The USB driver program 562 and connection manager program 564 may be prompted to be installed into the client device 152 by the WWAN control processor 530, when the user selects the physical USB interface 142 for data communication between the modem 132 and client device 152. The web UI launcher 566 may be prompted by the WWAN control processor 530 when the user selects the WLAN interface 160 for data communication between the modem 132 and client devices 152 and 154. The web UI launcher 566 can monitor and control the operation status of the modem 132 according to a user's selection of the physical USB interface 142 or the WLAN interface 160.

In one embodiment, the USB modem 132 may include an internal battery 570. The battery 570 may compensate for any difference between the maximum power (e.g., about 500 mmAh) provided through the USB interface 550 and the maximum power intermittently required by the modem 132 during operation. For example, when the modem 132 is consuming less than the maximum power provided by the USB interface 550, the battery 570 is charged by the external power source 170 or the client device 152 connected thereto via the USB interface 550. Furthermore, when the USB modem 132 temporarily requires more power than the USB modem can provide, the battery 570 discharges its power to maintain stable operation of the modem 132 or 134. In another embodiment, the modem 132 may use the internal battery 570 during normal operation.

In one embodiment, at least one of the USB modems 132 and 134 has the configuration of FIG. 5 so as to provide both the physical USB interface 142 and wireless USB interface 160. In another embodiment, at least one of the USB modems 132 and 134 is configured to provide only the wireless USB interface 160. In this embodiment, the USB modem 132 or 134 may not need the USB driver and CM software 562 and 564. Furthermore, the USB interface 550 may be used only for power supply provided from the computing device 152 or the external power source 170 connected thereto.

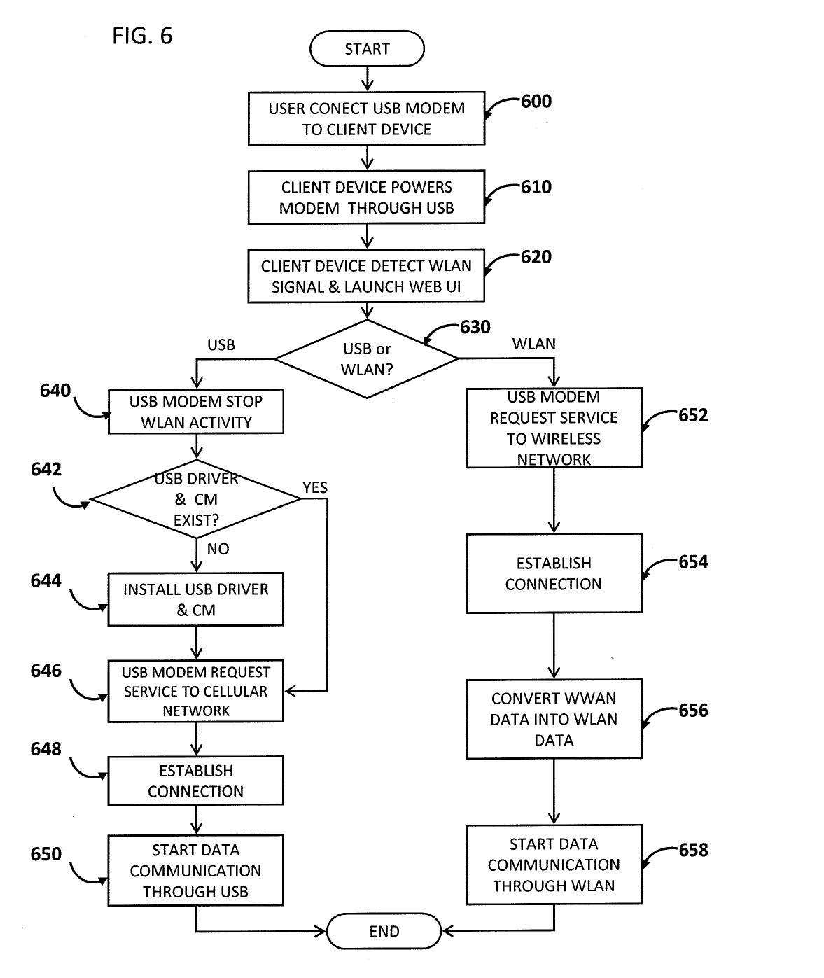

FIG. 6 is a flowchart showing one exemplary use and operation of the wireless USB modem 132, 134 from FIG. 3. In one embodiment, the FIG. 6 procedure (or at least part of the procedure) is implemented in a conventional programming language, such as C or C++ or another suitable programming language. In one embodiment, the program is stored on a computer accessible storage medium of the USB modem 132 or 134, for example, the memory 560 of FIG. 5. In another embodiment, the program can be stored in other system locations (e.g., client device 152 or 154) so long as it can perform at least part of the FIG. 6 procedure. In another embodiment, the program can be stored in a separate storage medium. The storage medium may comprise any of a variety of technologies for storing information. In one embodiment, the storage medium comprises a random access memory (RAM), hard disks, floppy disks, digital video devices, compact discs, video discs, and/or other optical storage mediums, etc. In another embodiment, at least one of the WWAN processor 530 and WLAN processor 540 is configured to or programmed to perform at least part of the FIG. 6 procedure. The program may be stored in the processor. In various embodiments, the processor may have a configuration based on, for example, i) an advanced RISC machine (ARM) microcontroller and ii) Intel Corporation's microprocessors (e.g., the Pentium family microprocessors).

In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, the procedure can be implemented with embedded software. Depending on the embodiment, additional states may be added, others removed, or the order of the states changes in FIG. 6.

Referring to FIGS. 3-5 and 7, the FIG. 6 procedure will be described. A user physically connects the USB modem 132 to the client device 152 (600). The client device 152 provides power to the attached USB modem 132 via the physical USB interface 142 (610). Once the modem 132 is powered, it transmits a WLAN signal to the client device 152 via the WLAN transceiver 520 (620). In one embodiment, the USB modem 132 coordinates with the cellular cell site 100 to establish a wireless packet data channel when the modem 132 is connected to the client device 152 and acquires power though the physical USB interface 142. The modem 132, then, activates the WLAN AP processor 540 to transmit a WLAN signal around the modem 132 via the WLAN transceiver 520.

When the client device 152 detects the WLAN signal, the modem 132 retrieves the web UI program 566 from the memory 560 and launches the web UI program 566 on the screen of the client device 152 to provide the user with a choice of data connection (630). In one embodiment, the user of the client device 152 is prompted to choose the physical USB interface 142 or the WLAN interface 160 (630).

If it is determined in state 630 that the physical USB interface 142 has been selected as data transmission media (“physical USB interface” mode), the modem 132 may deactivate the WLAN function, including discontinuing transmission of the WLAN signal (640). Then, it is determined whether a USB driver program and a CM program are already installed in the client device 152 (642). In one embodiment, if it is determined in state 642 that there is no USB driver and CM programs installed, the modem 132 retrieves and installs the USB driver and CM software 562 and 564, stored in the memory 560, into the client device 152 (644). In another embodiment, the state 642 is omitted, and the USB modem 132 directly installs the USB driver and CM software 562 and 564 into the client device 152.

If it is determined in state 642 that a USB driver and a CM software are already installed, or after the modem 132 installs the USB driver and CM software into the client device 152, the modem 132 requests a WWAN connection to the commercial cellular cell site 100 to which the user subscribes (646). Once the WWAN connection is established between the USB modem 132 and the cellular cell site 100 (648), the modem 132 starts data communication by, for example, converting WWAN data into USB data, and transmitting the USB data to the client device 132 via the physical USB interface 142 (650). In this mode, the physical USB interface 142 is used for both power supply and data transfer between the USB modem 132 and the client device 152. Furthermore, the modem 132 can be accessed only by the client device 152 physically connected thereto.

If it is determined in state 630 that the WLAN interface 160 has been selected, the modem 132 maintains the WLAN connection with the client device 152 and requests a WWAN connection from the commercial cellular cell site 100 (“WLAN interface” or “wireless interface” mode) (652). Once the WWAN connection is established (654), the modem 132 performs the WLAN interface 160, including converting the WWAN signal into the WLAN signal and vice versa (656, 658).

The USB modem 132 or 134 receives power from the client device 152 connected thereto or the external power source 170. In this WLAN interface mode, the user does not need to install USB driver and CM software into the client device 150, and can function as a standalone modem if it is connected to the external power source 170. As described above, at least one other client device 154 also has access to the USB modem 132 or 134 via the WLAN interface 160. Furthermore, the user of the client device 152 or the owner of the modem 132 or 134 can limit the number of accessible client devices through the WEB UI screen as shown in FIG. 7.

The USB modem according to at least one of the disclosed embodiments has the following advantages over the comparative USB modem described with respect to FIGS. 1 and 2. While the comparative USB modem can be used by only one client device attached thereto, the USB modem according to at least one embodiment can be plugged into either a client device or a separate power source. Furthermore, while the comparative USB modem can communicate data with only the attached client device, the USB modem according to at least one embodiment can provide data connection to the attached client device and detached client devices which are located within short-range wireless interface coverage such as WLAN, Blue Tooth or Zigbee.

Moreover, the USB modem according to at least one embodiment can relieve clients from having to select appropriate USB driver software for various operation systems (OS) and installing the USB driver software and CM application program into their devices to make physical connection to the USB modem.

While the above description has pointed out features of various embodiments, the skilled person will understand that various omissions, substitutions, and changes in the form and details of the device or process illustrated may be made without departing from the scope of the appended claims.

What is claimed is:

1. A wireless universal serial bus (USB) modem comprising:
a wireless wide area network (WWAN) transceiver configured to transmit and receive WWAN data via a public wireless network;
a physical USB interface configured to communicate USB data with and/or receive power from a first computing device;
a WWAN interface configured to interface between the USB data and the WWAN data;
a wireless local area network (WLAN) transceiver configured to transmit and receive WLAN data via a WLAN;
a WLAN interface configured to communicate data, via the WLAN, with the first computing device and/or at least one second computing device which is not physically connected to the modem;
a memory configured to store a USB driver program and a connection manager program, and a web user interface program; and
a controller being in data communication with the memory and configured to selectively activate the physical USB interface or the WLAN interface.

2. A wireless modem comprising:
a first transceiver configured to wirelessly transmit and receive first data according to a long-range communication standard;
a second transceiver configured to wirelessly transmit and receive second data according to a short-range communication standard;
a wireless interface configured to wirelessly communicate the second data with a first computing device according to the short-range communication standard; and
a controller configured to perform a signal conversion between the first data and second data.

3. The wireless modem of claim 2 further comprising a physical interface configured to communicate data with and/or receive power from the first computing device.

4. The wireless modem of claim 3 further comprising a memory configured to store a driver program, a connection manager program and a web user interface (UI) program, and being in data communication with the controller.

5. The wireless modem of claim 4, wherein the controller is configured to selectively activate the physical interface or the wireless interface.

6. The wireless modem of claim 3 further comprising a memory configured to store a web user interface (UI) program.

7. The wireless modem of claim 6, wherein the wireless interface is configured to wirelessly communicate the second data with at least one second computing device according to the short-range communication standard, and wherein the at least one second computing device is separate from the modem.

8. The wireless modem of claim 7, wherein the wireless interface is configured to wirelessly communicate the second data during a first time frame and communicate the data via the physical interface during a second time frame, the second time frame being different than the first time frame.

9. The wireless modem of claim 7, wherein the controller is configured to limit the number of the at least one second computing device sharing the wireless interface.

10. The wireless modem of claim 2, wherein the short-range communication standard comprises one of the following: a wireless local area network (WLAN), a Blue Tooth network and a Zigbee network.

11. The wireless modem of claim 2, wherein the long-range communication standard comprises one of the following: a code division multiple access (CDMA), a global system for mobile (GSM), an evolution data only (EVDO), a high speed packet access (HSPA), a long term evolution (LTE), and a WiMax network.

12. The wireless modem of claim 3 further comprising an internal battery configured to compensate for a difference between the maximum power provided through the physical interface and the maximum power intermittently required by the modem.

13. The wireless modem of claim 2 further comprising a physical interface connectable to an external power source.

14. The wireless modem of claim 2, wherein the wireless interface is configured to wirelessly communicate the second data with at least one second computing device in which a driver program and a connection manager program are not installed.

15. The wireless modem of claim 2, wherein the memory stores neither a driver program nor a connection manager program.

16. The wireless modem of claim 2 operating in compliance with the universal serial bus (USB) protocol.

17. A method of operating a wireless universal serial bus (USB) modem comprising:
wirelessly transmitting and receiving first data according to a long-range communication standard;
wirelessly transmitting and receiving second data according to a short-range communication standard;
wirelessly communicating the second data with a first computing device according to the short-range communication standard; and
performing, at a wireless USB modem, a signal conversion between the first data and the second data.

18. The method of claim 16 further comprising communicating USB data with and/or receiving power from the first computing device at least when the USB modem is physically connected to the first computing device.

19. The method of claim 17, wherein the USB data is communicated via a wired connection between the first computing device and the USB modem during a first time frame and wirelessly communicating the second data between the first computing device and the USB modem during a second time frame, the second time frame being different than the first time frame.

20. The method of claim 16 further comprising storing a USB driver program, a connection manager program and a web user interface program.

21. The method of claim 16, wherein the short-range communication standard comprises one of the following: a wireless local area network (WLAN), a Blue Tooth network and a Zigbee network.

22. The method of claim 16, wherein the long-range communication standard comprises one of the following: a code division multiple access (CDMA), a global system for mobile (GSM), an evolution data only (EVDO), a high speed packet access (HSPA), a long term evolution (LTE), and a WiMax network.

23. The method of claim 16 further comprising wirelessly communicating the second data with at least one second computing device according to the short-range communication standard, and wherein the at least one second computing device is separate from the USB modem.

24. One or more processor-readable storage devices having processor-readable code embodied on the processor-readable storage devices, the processor-readable code for programming one or more processors to perform a method of operating a wireless universal serial bus (USB) modem comprising:
wirelessly transmitting and receiving first data according to a long-range communication standard;
wirelessly transmitting and receiving second data according to a short-range communication standard;
wirelessly communicating the second data with a first computing device according to the short-range communication standard; and
performing, at a wireless USB modem, a signal conversion between the first data and the second data.

25. A wireless universal serial bus (USB) modem, comprising:
means for wirelessly transmitting and receiving first data according to a long-range communication standard;
means for wirelessly transmitting and receiving second data according to a short-range communication standard;
means for wirelessly communicating the second data with a first computing device according to the short-range communication standard; and
means for performing, at a wireless USB modem, a signal conversion between the first data and the second data.
